(19) United States
(12) Patent Application Publication
(10) Pub. No.: US 2012/0102979 A1
(43) Pub. Date: May 3, 2012

(54) NITROGEN FOG GENERATOR

(76) Inventor: Michael D. NEWMAN, Hillsborough, NJ (US)

(21) Appl. No.: 12/915,492

(22) Filed: Oct. 29, 2010

(51) Int. Cl. F17C 9/02

(52) U.S. Cl. 62/50.2

(57) ABSTRACT

A cryogenic fog generator is provided which includes a container having an interior in which liquid cryogen is disposed; an opening in the container from which the liquid cryogen can flow from the interior out of the container; a surface area upon which the flow of liquid cryogen is received; an ultrasonic transducer disposed proximate the opening for coacting with the surface area to transmit ultrasonic energy to the surface area and the liquid cryogen for providing a cryogenic fog. A method of producing a cryogenic fog is also provided.

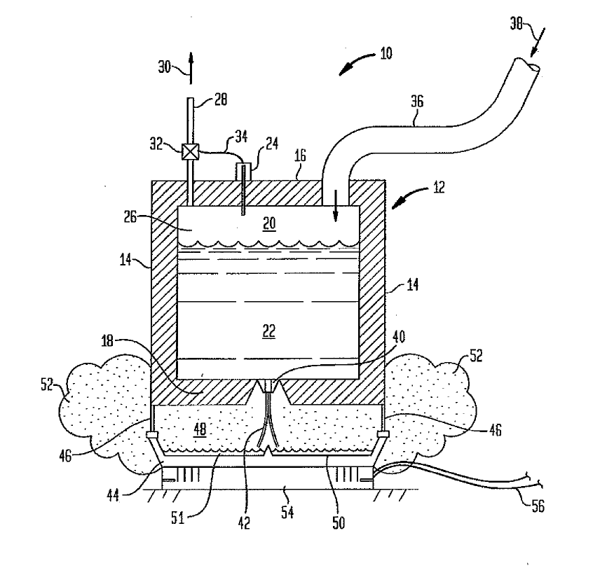

### BACKGROUND OF THE INVENTION

The present embodiments relate to chilling atmospheres in freezers.

A problem with conventional cryogenic sprays for freezers is that the sprays are heavier than gas present in the freezer atmosphere and therefore, the sprays tend to fall onto a specific area of a conveyor belt in the freezer, thereby creating localized, instead of uniform, areas of high heat transfer. In addition, known cryogen spray nozzles produce large liquid droplets which are not as effective at providing high evaporative heat transfer.

### BRIEF DESCRIPTION OF THE DRAWING

For a more complete understanding of the present embodiments, reference may be had to the following drawing figure taken in conjunction with the description of the embodiments, of which:

The Figure shows a nitrogen fog generator embodiment of the present invention.

### DETAILED DESCRIPTION OF THE INVENTION

There is currently no known method for creating a nitrogen fog or more specifically, a finely atomized liquid nitrogen spray which appears gaseous in nature, but is actually composed of very small droplets of liquid nitrogen.

With a nitrogen fog, a larger amount of freezing surface area can be covered effectively, efficiently and more uniformly. The fog can populate an entire freezing zone, if so desired, resulting in uniform, extremely high heat transfer rates throughout the freezing zone and production process.

Referring to the figure, a nitrogen fog generator embodiment is shown generally at 10 for use in a freezer (not shown), such as for example a cryogenic freezer. The fog generator 10 can also be used with mechanical freezers (not shown), such as for example by being disposed at a front end or a rear end of a mechanical freezer system. The fog generator 10 is used to increase or augment the heat transfer effect of an existing freezer, such as for example a nitrogen freezer.

The fog generator 10 includes a container 12 or vessel which can be vacuum jacketed. The container includes sidewalls 14, a top 16, a bottom 18 and an internal chamber 20 to which liquid nitrogen 22 can be introduced and contained.

A pressure transducer 24 is mounted to the top 16 for sensing pressure in the space 26 of the chamber 20 above a surface of the liquid cryogen 22. An exhaust pipe 28 or vent is in communication with the space 26 such that excess pressure in the space 26 can be vented through the pipe 28 in the direction of arrow 30. The space 26 includes gaseous pressure resulting from the phase change of liquid nitrogen in the chamber 20. A valve 32, such as a solenoid valve, is disposed in the exhaust pipe 28. Communication between the pressure transducer 24 and the solenoid valve 32 for actuation is through a wire 34 interconnecting the transducer 24 with the valve 32.

A pipe 36, which may be vacuum jacketed, is connected to the container 12 for communication with the internal chamber 20 for introducing the liquid cryogen 22, such as nitrogen, into the chamber 20. The pipe 36 is connected to a remote source of cryogen (not shown), which can provide the liquid cryogen under a pressure higher than atmospheric, as indicated by arrow 38 directed to the chamber 20.

The bottom 18 of the container 12 is constructed and arranged to provide a nozzle 40 in communication with the chamber 20 and through which the liquid cryogen 22 is directed under the effect of gravity in a flow shown generally at 42 for further application.

Disposed beneath the container 12 is a collection or capture plate 44 or pan constructed to collect the cryogen flow 42 emitted from the nozzle 40. A plurality of rods 46 or stanchions are provided in a number sufficient to support the container 12 above the pan 44 and in registration therewith so that the cryogen flow 42 emitted from the nozzle 40 is collected in the pan 44. The rods 46 provide for a sufficient amount or volume of space 48 between the bottom 18 of the container and an upper surface 50 of the pan 44.

Upon exposure of the liquid nitrogen 22 to the atmosphere of the space 48, the nitrogen liquid is disposed evenly onto the surface 50 of the pan 44 forming a reservoir 51 or pool of liquid nitrogen.

An ultrasonic transducer 54 is disposed beneath and in contact with the pan 44. Electrical leads 56 provide power from a remote source, such as a power generator (not shown), to actuate the transducer 54. The transducer may operate from between 10-45 kHz. The power generator (not shown) provides from 100 watts to 2 kilowatts (kW) of power. An alternative embodiment has the pan 44 constructed as an integral part of the transducer 54.

The upper surface 50 of the pan 44 is constructed to distribute the liquid nitrogen flow 42 so as to maximize surface area of the pool 51 of liquid nitrogen when being collected in the pan. As the liquid nitrogen comes into contact with the pan which is vibrated at a very high frequency by the transducer 54, the liquid nitrogen is atomized and dispersed away from the pan 54 as a nitrogen fog 52 to provide increased heat transfer effect in the freezing atmosphere for the product (not shown), which can be for example food products.

In the present embodiments, the liquid nitrogen 22 is delivered via the vacuum jacketed piping 36 to the chamber 20 of the vacuum jacketed container 12 with a venting system 24,28,32,34. The container 12 collects the liquid nitrogen 22 and lowers its pressure to atmospheric pressure. The pressure transducer 24 or a similar device mounted to the chamber 20 inside the container, senses pressure and subsequently actuates solenoid valve 32 to vent nitrogen gas and maintain a constant pressure in the chamber. The low pressure liquid nitrogen is discharged through the nozzle 40 onto the pan 44 which is in contact with the ultrasonic transducer 54. The pan 44 is designed to distribute the liquid nitrogen flow 42 to form the pool 51 in such as way as to maximize surface area coverage so that the pool 51 can be easily and uniformly atomized by the ultrasonic transducer 54. The nozzle 52 is sized so that the flow 42 into the pan 44 can be controlled. As the liquid nitrogen comes into contact with the pan 44 it is vibrated at very high frequency, atomized and then flows away from the device as a nitrogen fog 52. The transducer 54 is controlled by the power generator (not shown) which sets the correct power and frequency of the transducer.

The fog generator embodiment 10 or a plurality of same can be installed directly into a freezing zone of a cryogenic freezer.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. A cryogenic fog generator, comprising:
a container having an interior in which liquid cryogen is disposed;
an opening in the container from which the liquid cryogen can flow from the interior out of the container;
a surface area upon which the flow of liquid cryogen is received;
an ultrasonic transducer disposed proximate the opening for coacting with the surface area to transmit ultrasonic energy to the surface area and the liquid cryogen for providing a cryogenic fog.

2. The fog generator of claim 1, wherein the liquid cryogen comprises liquid nitrogen.

3. The fog generator of claim 1, further comprising a nozzle disposed in the opening for controlling the flow of the liquid cryogen.

4. The fog generator of claim 1, wherein the surface area of the ultrasonic transducer comprises a pan into which the liquid cryogen flow is received.

5. The fog generator of claim 1, wherein the surface area is integral with the ultrasonic transducer.

6. The fog generator of claim 1, further comprising at least one support member disposed to separate the container and the surface area for providing a space therebetween.

7. The fog generator of claim 1, further comprising a pressure assembly mounted to the container and in communication with the interior for maintaining the liquid cryogen at atmospheric pressure.

8. The fog generator of claim 1, further comprising a vacuum jacket surrounding an exterior surface of the container.

9. The fog generator of claim 1, further comprising a pipe having a first end in communication with the interior of the container and a second end in communication with a source of the liquid cryogen for providing the liquid cryogen to the interior of the container.

10. A method of producing a cryogenic fog, comprising: exposing a liquid cryogen to ultrasonic energy to phase change the liquid cryogen to a cryogen fog.

11. The method of claim 10, wherein the liquid cryogen comprises nitrogen.

12. The method of claim 10, further comprising containing the liquid cryogen at atmospheric pressure.

13. The method of claim 10, wherein the exposing of the liquid cryogen comprises providing a flow of the liquid cryogen to the ultrasonic energy.

14. The method of claim 13, wherein the providing the flow further comprises collecting the flow as a pool of liquid nitrogen.
